(19) United States
(12) Patent Application Publication
(10) Pub. No.: US 2014/0316858 A1
(43) Pub. Date: Oct. 23, 2014

(54) VIRTUAL BUSINESS PROCESS

(71) Applicant: INTERNATIONAL BUSINESS MACHINES CORPORATION, Armonk, NY (US)

(72) Inventors: Rahul P. Akolkar, Somers, NY (US); Rajesh Balasubramanian, Austin, TX (US); John M. Boyer, Victoria (CA); Donald E. Buddenbaum, Raleigh, NC (US); Karen B. Stanhope, Granby, CT (US); Richard A. Waugaman, JR., Raleigh, NC (US)

(73) Assignee: International Business Machines Corporation, Armonk, NY (US)

(21) Appl. No.: 13/864,506

(22) Filed: Apr. 17, 2013

(51) Int. Cl. G06Q 10/06

(52) U.S. Cl. CPC G06Q 10/0637
USPC 705/7.36

(57) ABSTRACT

A virtual process system includes a processor, a first physical business process coupled to the processor, and a second physical business process coupled to the processor. The processor is configured to execute a virtual business process according to a virtual business process definition. The processor is further configured to receive a first event relating to the first physical business process and a second event relating to the second physical business process. The processor is further configured to execute a first state transition in response to receiving the first event at the processor and execute a second state transition in response to receiving the second event at the processor and execute a behavior in response to a received event. The received event includes one of the first event or the second event.

### BACKGROUND

Monitoring and discovering patterns within business processes within an organization with many heterogeneous implementations of similar business process solutions may be difficult when the physical business processes vary. Aspects of many core business processes are common across business boundaries at a high level, but differ from a slight to a great degree according to product, market segment, or cultural differences. Additionally, utilizing the discoveries to initiate action based on the knowledge gained is difficult across the heterogeneous physical business processes. Existing techniques to monitor and discover patterns in business processes have drawbacks and may require extensive reengineering of existing physical business processes.

### SUMMARY

Embodiments of a virtual business process system are described. In one embodiment, a virtual process system includes a processor, a first physical business process coupled to the processor, and a second physical business process coupled to the processor. The processor is configured to execute a virtual business process according to a virtual business process definition. The virtual business process definition includes a set of states of a virtual business process, a set of events that may occur within the virtual business process, and a set of state transitions for the virtual business process. Each transition comprises a source state, a target state, and an event. The event triggers a state transition from the source state to the target state. The virtual business process definition further includes a set of behaviors for the virtual business process. Each behavior is a set of one or more actions to perform in response to a state transition. The processor is further configured to receive a first event relating to the first physical business process and a second event relating to the second physical business process. The processor is further configured to execute a first state transition in response to receiving the first event at the processor and execute a second state transition in response to receiving the second event at the processor and execute a behavior in response to a received event. The received event includes one of the first event or the second event. Other embodiments of the system are also described, as well as embodiments of a computer program product and a method.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a virtual business process system.

FIG. 2 depicts a schematic diagram of one embodiment of a virtual business process.

FIG. 3A depicts a schematic diagram of one embodiment of a virtual business process system executing a virtual business process according to a virtual business process definition.

FIG. 3B depicts a schematic diagram of another embodiment of a virtual business process system with additional functionality.

FIG. 4 depicts a schematic diagram of one embodiment of simple state machine interactions.

FIG. 5 depicts a flow chart diagram of one embodiment of a method for applying a virtual business process to at least two physical business processes.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate monitoring and discovering patterns within and across physical business processes of an organization despite many heterogeneous implementations of similar business process solutions and many heterogeneous physical business processes. Additionally, at least some of the described embodiments facilitate reducing redundancy of data reporting, increasing the breadth of focus of patterns across physical business processes, and overcoming the data model limitations of originating applications.

Monitoring and discovering emerging patterns in business processes may be simple and straightforward when analyzing a single business process from a single line of business. For a single process of a single line of business, the system utilized for publishing and reporting important events within the process may be as unique as the business process itself. Complexity occurs in monitoring and discovering emerging patterns in business processes across a heterogeneous mix of business processes and their corresponding physical business processes. Each physical business process may represent differing products, services, market segments, or even a single process within a line of business. Each physical business process may span business entities or represent a portion of a single business entity. In many instances, the physical business processes are incongruent. For example, a physical business process may be the processing of application for insurance, the manufacture of a product, inventory control, the process of delivering a service, or any other system implementing a physical business process. As a result, businesses may seek expensive and resource intensive business process reengineering of the physical business processes. However, the overall cost and the re-training required to implement the reengineering solutions may ultimately not be successful and may harm the physical business processes and physical executing systems.

In some embodiments described herein, an aspect of running a virtual business process is that any associated physical executing system or physical business process is equipped with the ability to emit the events defined by the virtual business process at those points where the physical business process enters a physical state that corresponds to a defined state of the virtual business process. In some embodiments, the events emitted by multiple physical business processes may be standardized, either by the organization that owns and operates the physical business processes or more generally by the vertical industry in which the organization operates. Standardization of events intentionally addresses the problem of changing from “apples to oranges” to “apples to apples.” Standardization of events normalizes the context of the business events in the physical business processes and the context of the business events of interest to the virtual business process.

A virtual business process differs from a traditional business process or physical executing system in that it does not describe a physical executable model that drives processing. Rather a virtual business process describes a business process monitoring model for one or more physical business processes (or business entities that span physical business processes). The states of the virtual business process do not necessarily define any sets of actions that occur and that result in a transition to another state of the physical business process. Instead, the virtual business process defines the business process states and, for each state, the events that can occur to transition to other states. A behavior or set of behaviors may optionally be associated with a state transition or with an exit from or entry into a state, and the most typical behavior is the production of a log message indicating the details of the state transition or the exit from or entry into a state.

Any physical business process or business entity may correspond to a whole or only a part of a virtual business process. In some embodiments, an advantage of a virtual business process system can be realized when multiple disparate physical business processes perform either the same business entity functions or logically equivalent business entity functions, particularly when the functions are performed by disparate lines of business (LOBs) or siloed (or compartmentalized) business units within a single line of business. From the high level perspective of the virtual business process, it can be seen that these disparate and distributed systems are achieving the same milestones. Moreover, in some embodiments, the exits, transitions and/or entries of the states of the virtual business process are equipped with logging behaviors. The log that develops can produce information about the relationships between or among the physical business processes or business entities as they emit events to the virtual business process. In some embodiments, an analytics engine is used to discover patterns that may lead to the determination of improvements to the physical business processes or business entities, and ultimately enable a feedback loop to validate the effectiveness of such improvements.

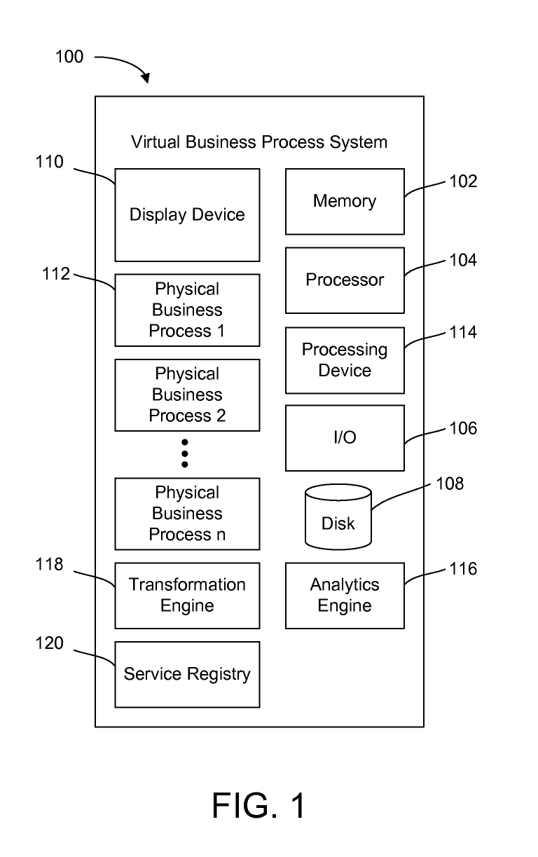

FIG. 1 depicts a schematic diagram of one embodiment of a virtual business process system 100. The depicted virtual business process system 100 includes various components, described below, that are capable of performing the functions and operations described herein. The illustrated virtual business process system 100 includes a computer memory device 102, a processor 104, input/output devices 106, and a disk storage device 108. The illustrated virtual business process system 100 also includes a display device 110 and multiple physical business processes 112. Additionally, the illustrated virtual business process system 100 includes a processing device 114, an analytics engine 116, a transformation engine 118, and a service registry 120. Some of the components of the virtual business process system 100 may be stored on a single computing device or on a network of computing devices, including a wireless communication network. Although the virtual business process system 100 is shown and described with certain components and functionality, other embodiments of the virtual business process system 100 may include fewer or more components to implement less or more functionality.

The computer memory device 102 may store data and/or software instructions or computer program instructions for carrying out the operations described herein. The computer memory device 102 may be external or internal to the system and may include but is not limited to a hard drive, a CD/DVD recordable drive, a magnetic tape drive, a disk cartridge drive, a secure digital card, another type of magnetic or optical drive, a solid-state drive, or another type of memory device. The processor 104 is connected to and in communication with the memory device 102 and may store and access data on the memory device 102 for performing the operations described herein. The processor 104 or processing device 114 may also be connected to the disk storage device 108. The disk storage device 108 may be implemented to temporarily store data or software instructions from the memory device 102 or the processor 104. The disk storage device 108 may include but is not limited to a hard disk drive, a floppy disk drive, a removable floppy disk, or other type of optical or magnetic drive. The functionality of the analytics engine 116 and the transformation engine 118 may be implemented by computer program instructions stored on the computer memory device 102 and executed by the processing device 114. In some embodiments, the analytics engine 116, and the transformation engine 118 are coupled to the processor 104. In some embodiments, the transformation engine 118 is coupled to one or more physical business processes 112.

In some embodiments, the processor 104 executes a virtual business process according to a virtual business process definition. In some embodiments, the virtual business process definition comprises a set of states of the virtual business process. In some embodiments, the virtual business process definition comprises a set of events that may occur within the virtual business process. In some embodiments, the virtual business process definition comprises a set of state transitions for the virtual business process. In some embodiments, each transition comprises a source state, a target state, and an event. The event triggers a state transition from the source state to the target state. In some embodiments, the virtual business process definition comprises a set of behaviors of the virtual business process. In some embodiments, each behavior comprises a set of zero or more actions to perform in response to a state transition. In some embodiments, the actions may be service invocations, email notifications, reports, service calls to the physical business processes 112, service calls to other interested parties, activity stream events, updates to an executive dashboard platform, and other similar actions.

In some embodiments, at least two disparate physical business processes 112 are coupled to the processor 104. In some embodiments, each physical business process 112 (physical business process 1, physical business process 2 . . . physical business process n) is equipped to emit at least one event relating to a physical business process to the processor 104. In some embodiments, the processor 104 is configured to receive a first event relating to a first physical business process and a second event relating to a second physical business process.

In some embodiments, the processor 104 is further configured to execute a state transition in response to receiving an event at the processor 104. In some embodiments, the processor 104 is configured to execute a first state transition in response to receiving a first event relating to a first physical business process 112 and execute a second state transition in response to receiving a second event relating to a second physical business process 112. In some embodiments, the processor 104 is further configured to execute a behavior in response to a state transition, the exit of a state, or the entry into a state. In some embodiments, the processor 104 is further configured to execute a behavior in response to a received event. In some embodiments, the received event includes one of the first event or the second event. In some embodiments, the executed behavior includes at least one action that emits a message to a virtual business process log. In some embodiments, the message indicates the received event that triggered the behavior. In some embodiments, the message indicates the source state, the target state, and the state transition. In some embodiments, the message indicates the exit of a state and the source state. In some embodiments, the message indicates the entrance into a state and the target state.

In some embodiments, the executed behavior includes at least one action that performs an invocation of a service. Some embodiments may include a service registry 120 coupled to the processor 104. In some embodiments, the service registry 120 stores a catalog of service invocations for all physical business processes 112. In some embodiments, the service registry 120 catalogs service invocations. In some embodiments, an entry of the service registry 120 maps the invocation of a service with a first service associated with a first physical business process 112. In some embodiments, an entry of the service registry 120 maps the invocation of a service with a second service associated with a second physical business process 112. In some embodiments, a service invocation processor invokes one of the first service or the second service in response to matching one of the first physical business process or the second physical business process as an origin of a received event that triggered an executed behavior.

Some embodiments include the analytics engine 116 coupled to the processor 104. In some embodiments, the analytics engine 116 is configured to apply a pattern detection analytic method to the virtual business process log. In some embodiments, the analytics engine 116 is configured to monitor and discover event patterns within the virtual business process. In some embodiments, the analytics engine 116 is configured to discover event patterns within or across multiple physical business processes 112. A pattern detection analytic method may be a specific, purpose-built algorithm to look for a specific pattern, or it may be a general algorithm that applies, for example, a statistical method. The pattern detection analytic method may be applied through a batch method or a streaming method. The algorithm may be a sequence labeling algorithm, a classification algorithm, a clustering algorithm, an ensemble learning algorithm, a parsing algorithm, a regression algorithm, or another general algorithm. In some embodiments, the virtual business process log may receive transaction records, business process logs, communications records, historical information, or any other data relevant to a computation of a business process of interest.

Some embodiments include the display device 110. In some embodiments, the display device displays the virtual business process. In some embodiments, the display device displays a representation of the virtual business process log and emerging patterns captured by the analytics engine 116.

Some embodiments include a transformation engine 118 coupled to one of the physical business processes 112 or to processor 104. In some embodiments, the transformation engine 118 is configured to translate an event of interest emitted by a physical business process into the event received at the processor 104. The event of interest may not be compatible with the virtual business process definition and may need to be translated into an event that is compatible with the virtual business process definition. In some embodiments, the processor 104 is configured to monitor event of interest feeds from the transformation engine 118. In some embodiments, more than transformation engine 118 exists, and more than one of the physical business processes 112 has an associated transformation engine. In some embodiments, event feeds of the physical business processes 112 are monitored.

In some embodiments, the physical business processes 112 are equipped to emit events or events of interest by inserting event publishing logic corresponding to events as executed by business entities. In some embodiments, the physical business processes 112 are equipped to emit events via middleware. In some embodiments, equipping the physical business processes to emit events would not require reengineering of the physical business process. In some embodiments, the events are emitted in real time. In some embodiments, the events are emitted in near real time. In some embodiments, the events are emitted as part of batched extracts.

In addition to the advantages which may be achieved by implementation of the individual components of the virtual business process system 100, some embodiments of the virtual business process system 100 provide additional advantages over conventional technology. For example, some embodiments of the virtual business process system 100 allow a virtual business process to apply to more than one physical business process according to a virtual business process definition without reengineering the physical business processes to be compatible and without training the operators of the existing physical business processes.

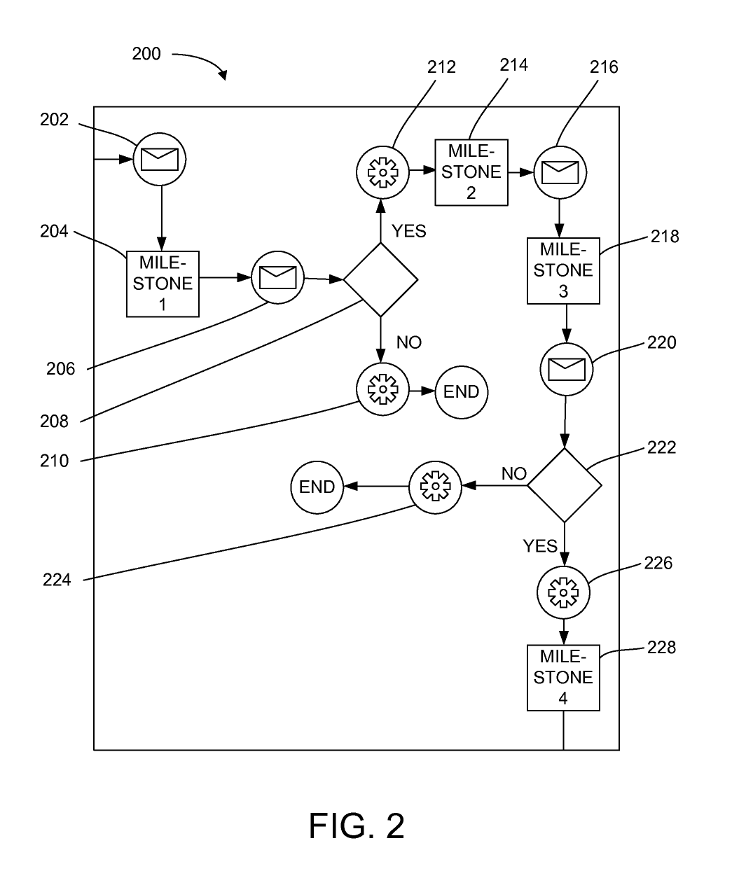

FIG. 2 depicts a schematic diagram of one embodiment of a virtual business process 200. The illustrated embodiment depicts receipt of an event or event of interest 202 leading to entry of a state 204, labeled “milestone 1.” Event 206 exits the process from state 204 upon which a decision 208 is made. A “no” decision will result in behavior 210 after which the process would end. A “yes” decision will result in behavior 212 and entry into state 214. For one example, behavior 210 and behavior 212 may be log entries. Event 216 results in a state transition from state 214 to state 218. Event 220 exits the process from state 218 upon which a decision 222 is made. A “no” decision will result in behavior 224 after which the process will end. For one example, behavior 224 may be a log entry and a service call. A “yes” decision will result in behavior 226 and a state transition to state 228. For one example, behavior 226 may be a log entry. The process may continue in similar fashion. In some embodiments, the exit of a state, the entry of a state, or a state transition results in a behavior. In some embodiments, each behavior is a set of one or more actions performed in response to a state transition.

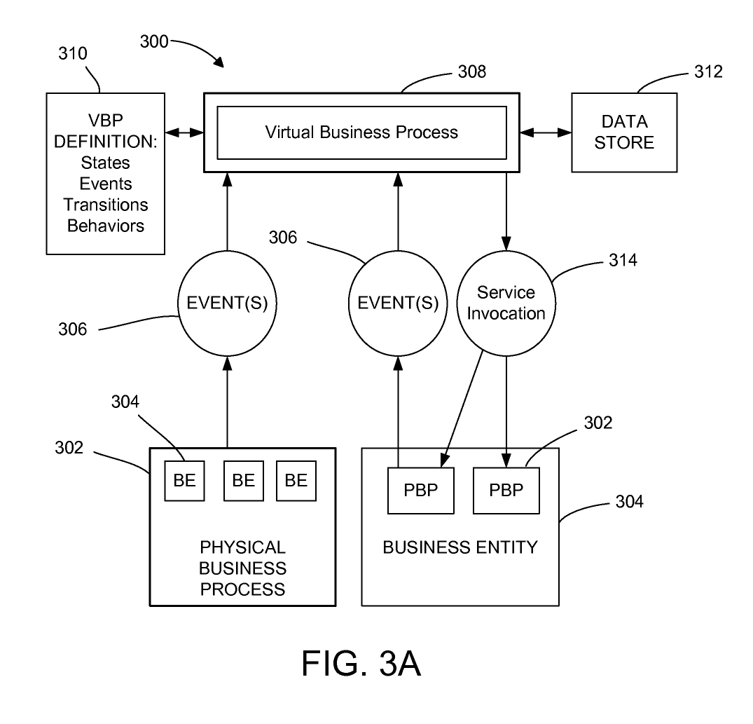

FIG. 3A depicts a schematic diagram of one embodiment of a virtual business process system 300. The illustrated embodiment depicts physical business processes 302. In some embodiments, the physical business processes 302 span multiple business entities 304. In some embodiments, the physical business processes may be one part of single business entity 304. In some embodiments, the physical business processes 302 are combinations of both. The physical business processes 302 emit event(s) 306. The event(s) 306 relating to the physical business processes 302 are received at a processor 308. In some embodiments, the physical business processes 302 are configured to publish events to a processor 308. In some embodiments, the processor 308 is configured to execute a virtual business process according to a virtual business process definition 310. In some embodiments, the virtual business process definition 310 includes a set of states of the virtual business process. In some embodiments, the virtual business process definition 310 includes a set of events that may occur within the virtual business process. In some embodiments, the virtual business process definition 310 includes a set of state transitions for the virtual business process. In some embodiments, each transition comprises a source state, a target state, and an event. In some embodiments, the event triggers a state transition from the source state to the target state. In some embodiments, the virtual business process definition 310 includes a set of behaviors for the virtual business process. In some embodiments, each behavior is a set of one or more actions to perform in response to a state transition. In some embodiments, the processor 308 is configured to execute a state transition in response to receiving an event 306. In some embodiments, the processor 308 is configured to execute a behavior in response to a state transition. In some embodiments, the processor 308 is configured to emit a message to a virtual business process log persisted to data store 312. In some embodiments, the message indicates the event 306 which triggered a behavior. In some embodiments, the message indicates the source state, the target state, and the state transition. In some embodiments, the message indicates the exit of a state and the source state. In some embodiments, the message indicates the entry into a state and the target state. In some embodiments, the action performed is a service invocation 314. In some embodiments, a service invocation 314 communicates with one or more of the physical business processes 302.

FIG. 3B depicts a schematic diagram of another embodiment of a virtual business process system 300. The embodiment illustrated is similar to FIG. 3A with variations shown and additional functionality. Event(s) of interest 320 emitted by the physical business processes 302 are communicated to a software architecture model 316. In some embodiments, the software architecture model 316 may be an enterprise service bus. In some embodiments, the event interface of each physical business process 302 may be different and not compatible with the interface of the virtual business process. In some embodiments, an event registry 318 within the software architecture model 316 manages the registry of publishers and subscribers of events, and may use the registry 318 to determine the virtual business process to which the event should be sent. Additionally, in some embodiments, the event registry 318 provides maps supporting transformation of events of interest 320 from the physical business process format to the virtual business process format. In some embodiments, events of interest 320 are translated into virtual business process compatible events 306. Events 306 are then communicated to the processor 308.

In some embodiments, a virtual service invocation 322 is communicated to the software architecture model 316, which may utilize an entry of a service registry 324 to map the virtual service invocation 322 with a service associated with a physical business process 302. In some embodiments, a service invocation processor invokes the service in response to matching the physical business process as the origin of the event that triggered the executed behavior. The software architecture model 316 may then send a service invocation 314 to the appropriate system or entity. In some embodiments, the service invocation 314 is sent to other interested parties 326. In some embodiments, an action may be different than a service invocation and may include email notifications, reports, service calls to the physical business processes 302, service calls to other interested parties 326, activity stream events, and other similar actions.

In some embodiments, the service invocation processor of the software architecture model 316 communicates with the virtual business process log in data store 312 or with other data in the data store 312. In some embodiments, an analytics engine 328 monitors the data store 312 and applies a pattern detection analytic method to discover emerging patterns within the virtual business process and the individual physical business processes 302. In some embodiments, the analysis and patterns are communicated to a portal 330 and displayed along with the virtual business process.

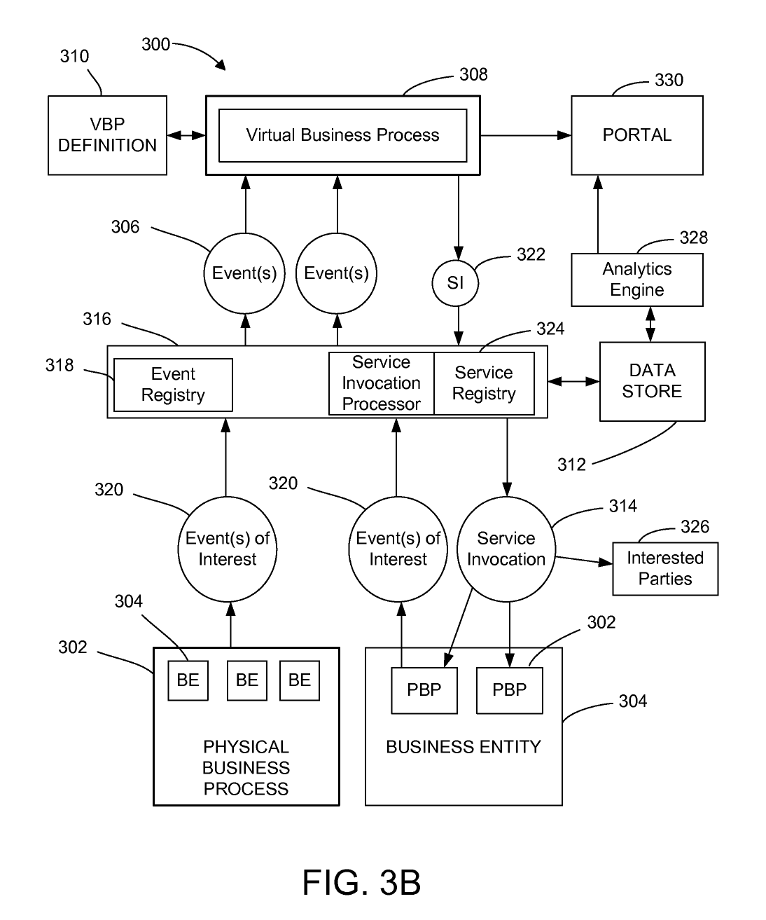

FIG. 4 depicts a schematic diagram of one embodiment of simple state machine interactions 400. In a first state 402, labeled “state 1”, an event 408 results in a state transition to state 2 404. An event 410 results in a state transition to state 2 406. An event 412 results in a state transition to state 1 402. In one embodiment, a virtual business process is implemented with State Chart XML, or SCXML. The virtual business process definition may be SCXML files stored in a repository and the processor is a SCXML processor.

In one embodiment, these interactions can be encoded as the following SCXML markup:

```
<?xml version=”1.0” encoding=”UTF-8”?>
<scxml xmlns=”...” ... initial=”state1”>
  <state id=”state1”>
    <transition event=”e1” target=”state2”/>
    <onexit>
      <log label=″[info]″ expr=″Leaving state1″/>
    </onexit>
  </state>
  <state id=”state2”>
    <transition event=”e2” target=”state3”/>
    <transition event=”e3” target=”state1”>
      <log label=″[info]″ expr=″Transitioning for
event e3, from state2 to state1″/>
    </transition>
  </state>
  <state id=″state3″>
    <onentry>
      <log label=″[info]″ expr=″Entering state3″/>
    </onentry>
  </state>
</scxml>
```

In some embodiments, the SCXML may attach a service call to state exit, a state transition, or a state entry.

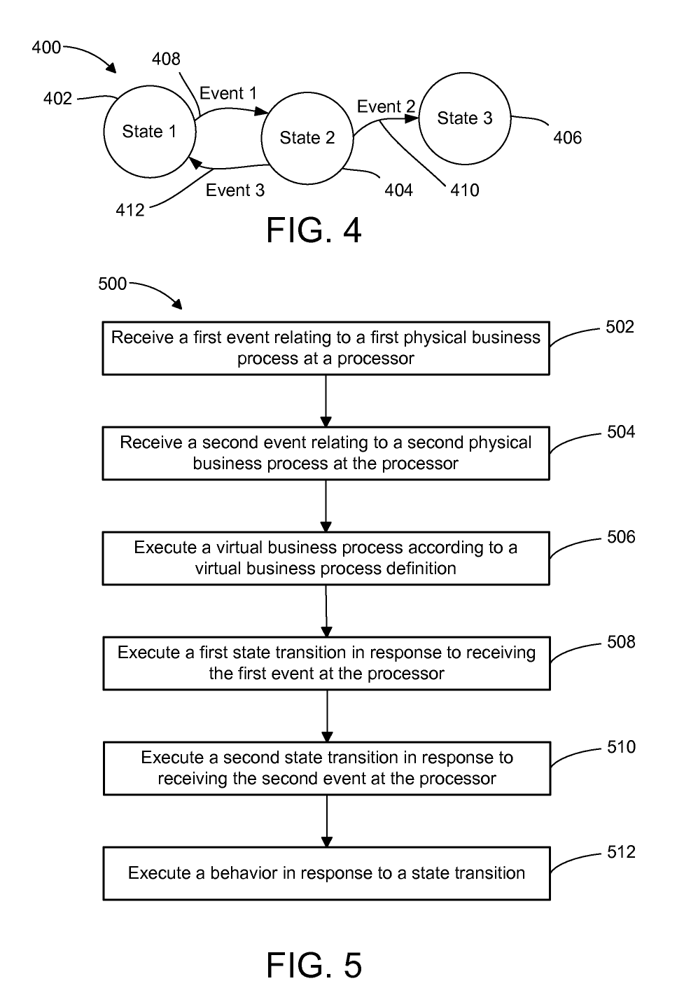

FIG. 5 depicts a flow chart diagram of one embodiment of a method for applying a virtual business process 500 to at least two physical business processes 112. Although the method 500 for applying a virtual business process is described in conjunction with the virtual business process system described in FIGS. 1-4, embodiments of the method 500 may be implemented with other types of computer systems.

At 502, at least one event 306 relating to a first physical business process 302 is received at a processor 308. At 504, a second event 306 relating to a second disparate physical business process 302 is received at the processor 308. At 506, a virtual business process is executed according to a virtual business process definition 310. At 508, a first state transition within the virtual business process is executed in response to receiving the first event 306 at the processor 308. At 510, a second state transition within the virtual business process is executed in response to receiving the second event 306 at the processor 308. At 512, a behavior is executed in response to a state transition. The depicted method 500 for applying a virtual business process to at least two physical business processes 112 then ends, or it may continue listening for and processing further events 306 by performing additional state transitions and their associated behaviors until the virtual business process definition indicates that it has reached an end state as is shown in FIG. 2.

In some embodiments of the method 500, the virtual business process definition comprises a set of states 402-406 of the virtual business process. In some embodiments, the virtual business process definition comprises a set of events 408-412 that may occur within the virtual business process. In some embodiments, the virtual business process definition comprises a set of state transitions for the virtual business process. In some embodiments, each transition comprises a source state 402, a target state 404, and an event 408. The event 408 triggers a state transition from the source state 402 to the target state 404. In some embodiments, the virtual business process definition comprises a set of behaviors of the virtual business process. In some embodiments, each behavior comprises a set of one or more actions to perform in response to a state transition.

Other embodiments of the method 500 may include some or all the operations and steps as described above in conjunction with FIGS. 1-4 in various combinations and are not expounded upon for the sake of brevity.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a virtual business process system includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method for applying a virtual business process to at least two physical business processes, the method comprising:
receiving a first event relating to a first physical business process at a processor;
receiving a second event relating to a second physical business process at the processor;
executing the virtual business process according to a virtual business process definition, wherein the virtual business process definition comprises a set of states of the virtual business process, a set of events that may occur within the virtual business process, a set of state transitions for the virtual business process, and a set of behaviors of the virtual business process, wherein each state transition comprises a source state, a target state, and an event, wherein the receiving of the event triggers a state transition from the source state to the target state, and wherein each behavior comprises a set of one or more actions to perform in response to a state transition; and
executing a first state transition in response to receiving the first event at the processor;
executing a second state transition in response to receiving the second event at the processor; and
executing a behavior in response to a received event, wherein the received event comprises one of the first event or the second event.

2. The method of claim 1, wherein the executed behavior comprises at least one action, wherein the at least one action emits a message to a virtual business process log, wherein the message indicates the received event that triggered the executed behavior, and wherein the message further indicates one of the following: the source state, the target state, and the state transition; the exit of a state and the source state; or the entrance into a state and the target state.

3. The method of claim 2, further comprising displaying a representation of the virtual business process log and the virtual business process on a display device.

4. The method of claim 1, wherein the executed behavior comprises at least one action that performs an invocation of a service.

5. The method of claim 4, further comprising cataloguing service invocations within a service registry, wherein an entry of the service registry maps the invocation of the service with a first service associated with the first physical business process, wherein the entry of the service registry maps the invocation of the service with a second service associated with the second physical business process, and wherein a service invocation processor invokes one of the first service or the second service in response to matching one of the first physical business process or the second physical business process as an origin of the received event that triggered the executed behavior.

6. The method of claim 2, further comprising applying a pattern detection analytic method to the virtual business process log.

7. The method of claim 1, further comprising translating an event of interest emitted by one of the first physical business process or the second physical business process into one of the first event or the second event, wherein the event of interest is not compatible with the virtual business process definition, and wherein the first event and second event are compatible with the virtual business process definition.

8. A virtual business process system, the system comprising:
a processor;
a first physical business process coupled to the processor;
a second physical business process coupled to the processor;
wherein the processor is configured to execute a virtual business process according to a virtual business process definition, wherein the virtual business process definition comprises a set of states of the virtual business process, a set of events that may occur within the virtual business process, a set of state transitions for the virtual business process, and a set of behaviors of the virtual business process, wherein each state transition comprises a source state, a target state, and an event, wherein the receiving of the event triggers a state transition from the source state to the target state, and wherein each behavior comprises a set of one or more actions to perform in response to a state transition;
wherein the processor is configured to receive a first event relating to the first physical business process and a second event relating to the second physical business process;
wherein the processor is further configured to execute a first state transition in response to receiving the first event at the processor and execute a second state transition in response to receiving the second event at the processor; and
wherein the processor is further configured to execute a behavior in response to a received event, wherein the received event comprises one of the first event or the second event.

9. The virtual business process system of claim 8, wherein the executed behavior comprises at least one action that emits a message to a virtual business process log indicating the received event that triggered the behavior, wherein the message indicates one of the following: a source state, a target state and a state transition; an exit of a state and a source state; or an entrance into a state and a target state.

10. The virtual business process system of claim 9, wherein the system further comprises a display device, and wherein the system is further configured to display a representation of the virtual business process log and the virtual business process on the display device.

11. The virtual business process system of claim 9, wherein the system further comprises an analytics engine coupled to the processor, wherein the analytics engine is configured to apply a pattern detection analytic method to the virtual business process log.

12. The virtual business process system of claim 8, wherein the executed behavior comprises at least one action that performs an invocation of a service.

13. The virtual business process system of claim 12, wherein the system further comprises a service registry coupled to the processor, wherein the service registry catalogs service invocations, wherein an entry of the service registry maps the invocation of the service with a first service associated with the first physical business process, wherein the entry of the service registry maps the invocation of the service with a second service associated with the second physical business process, and wherein a service invocation processor invokes one of the first service or the second service in response to matching one of the first physical business process or the second physical business process as an origin of the received event that triggered the executed behavior.

14. The virtual business process system of claim 8, wherein the system further comprises a transformation engine coupled to one of the first physical business process or the second physical business process, wherein the transformation engine is configured to translate an event of interest emitted by one of the first physical business process or the second physical business process into one of the first event or the second event, wherein the event of interest is not compatible with the virtual business process definition, and wherein the first event and second event are compatible with the virtual business process definition.

15. A computer program product comprising:
a computer useable storage medium including a computer readable program, wherein the computer readable program includes instructions that, when executed by a processing device within a computer, cause the computer to perform operations comprising:
receiving a first event relating to a first physical business process at a processor;
receiving a second event relating to a second physical business process at the processor;
executing a virtual business process according to a virtual business process definition, wherein the virtual business process definition comprises a set of states of the virtual business process, a set of events that may occur within the virtual business process, a set of state transitions for the virtual business process, and a set of behaviors of the virtual business process, wherein each state transition comprises a source state, a target state, and an event, wherein receipt of the event triggers a state transition from the source state to the target state, and wherein each behavior comprises a set of one or more actions to perform in response to a state transition; and
executing a first state transition in response to receiving the first event at the processor;
executing a second state transition in response to receiving the second event at the processor; and
executing a behavior in response to a received event, wherein the received event comprises one of the first event or the second event.

16. The computer program product of claim 15, wherein the executed behavior comprises at least one action, wherein the at least one action emits a message to a virtual business process log, wherein the message indicates the received event that triggered the executed behavior, and wherein the message further indicates one of the following: the source state, the target state, and the state transition; the exit of a state and the source state; or the entrance into a state and the target state.

17. The computer program product of claim 16, wherein the operations further comprise displaying a representation of the virtual business process log and the virtual business process on a display device.

18. The computer program product of claim 16, wherein the operations further comprise applying a pattern detection analytic method to the virtual business process log.

19. The computer program product of claim 15, wherein the executed behavior comprises at least one action that performs an invocation of a service.

20. The computer program product of claim 19, wherein the operations further comprise cataloguing service invocations within a service registry, wherein an entry of the service registry maps the invocation of the service with a first service associated with the first physical business process, wherein the entry of the service registry maps the invocation of the service with a second service associated with the second physical business process, and wherein the service invocation processor invokes one of the first service or the second service in response to matching one of the first physical business process or the second physical business process as an origin of the event that triggered the executed behavior.
